(19) United States
(12) Patent Application Publication
(10) Pub. No.: US 2017/0163800 A1
(43) Pub. Date: Jun. 8, 2017

(54) METHODS AND ELECTRONIC DEVICE FOR TESTING CALL DROP

(71) Applicants: LE HOLDINGS (BEIJING) CO., LTD., Beijing (CN); LEMOBILE INFORMATION TECHNOLOGY (BEIJING ) CO., LTD., Beijing (CN)

(72) Inventor: Gang WANG, Beijing (CN)

(21) Appl. No.: 15/240,901

(22) Filed: Aug. 18, 2016

Related U.S. Application Data
(63) Continuation of application No. PCT/CN2016/089252, filed on Jul. 7, 2016.

(30) Foreign Application Priority Data
Dec. 8, 2015 (CN) 201510898098.1

(51) Int. Cl. H04M 3/42; H04M 3/22; H04W 24/08

(52) U.S. Cl. CPC H04M 3/42221; H04W 24/08; H04M 3/2218

(57) ABSTRACT

The present disclosure discloses a method and an electronic device for testing call drop, wherein the method includes: initiating a conversation; continuously monitoring a symbol error rate on a physical layer; determining that a call drop risk event occurs if the symbol error rate is higher than a preset symbol error rate threshold and the duration exceeds a preset first time period threshold; starting to record a conversation log on account of the call drop risk event; and saving the conversation log and uploading it to a server if the conversation ends abnormally. By the method and the device for testing call drop according to the disclosure, a LOG can be obtained in time and call drop data can be analyzed, and moreover, no excessive space will be occupied.

### CROSS-REFERENCE TO RELATED APPLICATION

This application is a continuation of International PCT Patent Application No. PCT/CN2016/089252, filed Jul. 7, 2016 (attached hereto as an Appendix), and claims benefit/priority of Chinese patent application entitled “Method And Electronic Device For Testing Call Drop”, application number 201510898098.1, filed with the State Intellectual Property Office of China on Dec. 8, 2015, which are all incorporated herein by reference in entirety.

### TECHNICAL FIELD

The present disclosure relates to the technical field of communication test, and in particular, to a method and an electronic device for testing call drop.

### BACKGROUND

In wireless communication, call drop is a common phenomenon. In order to guarantee that no call drop problem occurs in a mobile phone, during research and development of mobile phones, a tester at present needs to manually perform tests and obtain a call log (LOG, for short below), then provide it to a research staff for analysis; the whole process is accomplished by the tester manually, and a long time needs to be spent; at the same time, the tester needs to stay alert all the time, so that a call drop time point can be obtained at any moment; but in a lot of cases, if the tester does not get prepared ahead of time, no valid LOG can be obtained, and the call drop scene will be missed.

For the testing party, in a prior art solution, a tester usually needs to manually initiate a LOG recorder or a LOG recording module via a tool before a conversation starts; after a call drop occurs, the tester needs to manually save the LOG recorded and manually submit it to the research staff. However, in such a technical solution, a tester needs to track a large number of conversations and artificially judge whether there is a call drop, thus the labor cost is high; moreover, a manual obtainment of LOGs is adverse to analyzing call drop data, and tends to cause data missing; further, an analysis also requires a labor cost.

For a mobile phone terminal, in a prior art solution, a user may record a LOG by manually initiating a LOG recording unit in a mobile phone communication module (modem) of the mobile phone, and a call drop problem occurs during recording will be recorded in the LOG and uploaded to a server via the mobile phone for being analyzed by research staffs of the mobile phone manufacturer. However, LOG information volume of a mobile phone communication module (modem) by current main mobile phone chip manufacturers is large, and a storage space will be fully occupied very soon if the LOG is always open during the use of the mobile phone; on the other hand, if the LOG is not initiated until a call drop occurs, the optimum opportunity for obtaining the LOG has usually been missed.

### SUMMARY

Therefore, it is an object of the present disclosure to provide a method and an electronic device for testing call drop, thereby a LOG can be obtained and call drop data can be analyzed in time, and moreover, no excessive space will be occupied.

In the first aspect, a method for testing call drop provided by an embodiment of the present disclosure based on the above object includes:

initiating a conversation;

continuously monitoring a symbol error rate on a physical layer;

determining that a call drop risk event occurs if the symbol error rate is higher than a preset symbol error rate threshold and the duration exceeds a preset first time period threshold;

starting to record a conversation log on account of the call drop risk event; and

saving the conversation log and uploading it to a server if the conversation ends abnormally.

In the second aspect, an embodiment of the present disclosure further provides a computer storage medium on which a program is stored, when executed, the program may carry out part of or all of the steps in each implementation mode of the above method for testing call drop according to the disclosure.

In the third aspect, an embodiment of the present disclosure further provides an electronic device that includes: at least one processor and a memory for storing instructions executable by the at least one processor, wherein the instructions are configured for executing any one of the above methods for testing call drop according to the present disclosure.

It may be seen from above that, in the method and the device for testing call drop according to the disclosure, a call drop conversation log (LOG) is automatically obtained and uploaded to a server by monitoring the symbol error rate on the physical layer during a conversation, so that the whole obtaining and uploading process can be automatically accomplished in a terminal while a user or a tester merely normally uses the mobile phone; moreover, by carrying out a test based on the symbol error rate monitoring result, the terminal only obtains conversation logs in a call drop conversation, thus no large amount of invalid conversation logs may be generated and occupy the storage space of the terminal; because the symbol error rate is taken as the basis (for judgement), in case a call drop occurs, the probability of missing a drop scene may be lowered because a record of the conversation log has already been initiated before the call drop; additionally, the conversation log is automatically sent to the server, which is favorable for counting and further analyzing.

### BRIEF DESCRIPTION OF THE DRAWINGS

One or more embodiments are illustrated by way of example, and not by limitation, in the figures of the corresponding accompanying drawings, wherein elements having the same reference numeral designations represent like elements throughout. The drawings are not to scale, unless otherwise disclosed.

FIG. 1 is a schematic flow chart of an embodiment of a method for testing call drop according to an embodiment of the present disclosure;

FIG. 2 is a schematic flow chart of another embodiment of a method for testing call drop according to the an embodiment of the present disclosure;

FIG. 3 is a schematic diagram showing a module structure of an embodiment of a device for testing call drop according to the an embodiment of the present disclosure; and

FIG. 4 is a schematic diagram showing a structure of the electronic device according to the an embodiment of the present disclosure.

### DETAILED DESCRIPTION

The disclosure will be further discussed in detail below in conjunction with the specific embodiments together with the drawings to make the objects, technical solutions and advantages of the disclosure more clear.

It should be noted that, all the expressions of “first” and “second” employed in the embodiments of the disclosure are used for distinguishing two different entities or parameters with the same name from each other. Thus, it may be seen that “first” and “second” are merely used for the sake of a convenient description, rather than limiting the embodiments of the disclosure, and this will not be specifically explained in the subsequent embodiments.

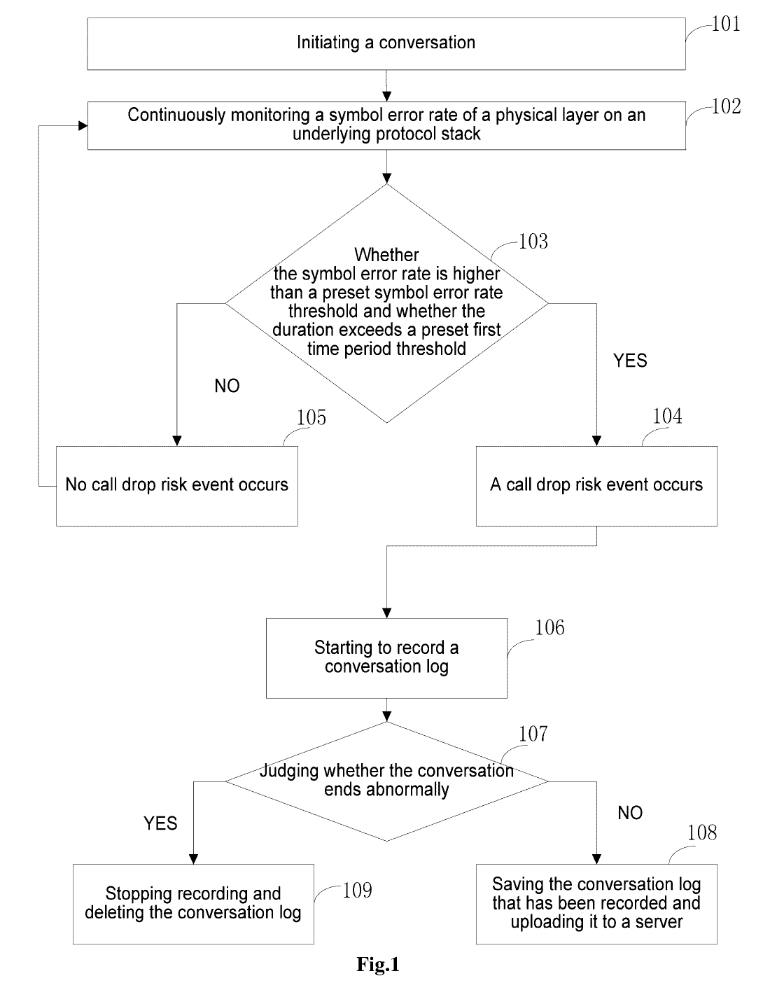

In the first aspect of the disclosure, there provides a method for testing call drop, by which a LOG can be obtained and the call drop data can be analyzed in a timely fashion, and moreover, no excessive space will be occupied. As shown in FIG. 1, it is a schematic flow chart of one embodiment of the method for testing call drop according to the disclosure.

The method for testing call drop includes the following steps:

In step 101: a conversation is initiated. That is, a mobile terminal is turned on and a conversation mode is initiated.

In step 102: a symbol error rate of a physical layer on an underlying protocol stack is monitored continuously.

Symbol error rate (SER) is an index for measuring a data transmission accuracy of data during a specified time period. Symbol error rate =Error Symbol Count During Transmission/Total Symbol Count Transmitted×100%. If there is an error symbol, there would be a symbol error rate. Because a voltage of a signal may be changed due to degradation during signal transmission, the signal will be damaged during transmission, and as a result an error symbol will be generated. Noise, a pulse caused by alternating current or lightning, transmission device failure and other factors may all result in a symbol error rate (for example, the signal transferred is 1, but the signal received is 0; and vice versa). Due to various reasons, it is inevitable that an error may be generated during the transmission of digital signals. For example, a signal transferred may be distorted due to external disturbance during transmission or unsatisfactory quality of respective components in a communication system. When the disturbance or the signal distortion reaches a certain degree, an error will be generated. Bit error rate (BER) is an index for measuring a data transmission accuracy of data during a specified time period. Symbol error rate=Count of Error Code Elements/Count Of Total Code Elements Transmitted. Bit error rate=Count Of Error Bits/Count Of Total Bits Transmitted. Symbol error rate/Bit error rate are the most commonly used index for data communication transmission quality. It indicates the transmission quality of a digital system by way of “one error bit among how many data bits”.

In step 103: it is determined whether the symbol error rate is higher than a preset symbol error rate threshold (Vcrc) and whether the duration exceeds a preset first time period threshold.

In step 104: it is determined that a call drop risk event occurs (the protocol stack reports to a high level conversation module) if the symbol error rate is higher than the preset symbol error rate threshold (Vcrc) and the duration exceeds the preset first time period threshold (Tcrc). That is, in such a case, a call drop risk tends to occur; the symbol error rate threshold is set according to different communication signals respectively, for example, symbol error rate thresholds for a GSM signal, for a 3G signal and for a 4G signal are different, and should be specifically set according to specific situations; similarly, the first time period threshold also needs to be specifically set according to different specific situations.

In step 105: it is determined that no call drop risk event occurs and to return to step 102 for a continuous monitoring of the symbol error rate on the physical layer, if the symbol error rate is no higher than the preset symbol error rate threshold, or if the symbol error rate is higher than the preset symbol error rate threshold but the duration does not exceed the preset first time period threshold and the symbol error rate again falls below the symbol error rate threshold;

In step 106: a record of a conversation log is started on account of the call drop risk event (the conversation module notifies the log module to initiate a modem-side LOG). That is, a log record function is initiated at this point, and it starts to record the conversation log in real time so as to record the oncoming call drop event in the LOG.

In step 107: it is judged whether the conversation ends abnormally.

In step 108: the conversation log that has been recorded is saved and uploaded to a server for a research staff to study the reason of the call drop event, if the conversation ends abnormally (a call drop event occurs).

In step 109: the record of the conversation log is stopped, and the conversation log recorded is deleted, if the conversation ends normally.

It may be seen from the above embodiment that, in the method for testing call drop according to the disclosure, a call drop conversation log (LOG) is automatically obtained and uploaded to a server by monitoring the symbol error rate on the physical layer during a conversation, so that the whole obtaining and uploading process may be accomplished automatically in a terminal while a user or a tester only needs to use the mobile phone normally; moreover, by carrying out a test based on the symbol error rate monitoring result, the terminal only obtains the conversation log in a call drop conversation, thus no large amount of invalid conversation logs will be generated and occupy the storage space of the terminal; moreover, because the symbol error rate is taken as the basis (for judgement), in case a call drop occurs, the probability of missing a drop scene may be lowered because a record of the conversation log has already been initiated before the call drop; additionally, the conversation log is automatically sent to the server, which is favorable for counting and further analyzing.

Further, in some optional implementation modes, after the step 105 of starting to record a conversation log, the method may further include the steps of:

continuously monitoring the symbol error rate on the physical layer; and

stopping recording the conversation log if the symbol error rate is lower than the symbol error rate threshold at a certain time point during record of the conversation log.

Or, further, in other optional implementation modes, after the step 105 of starting to record a conversation log, the method may further include the steps of:

continuously monitoring the symbol error rate on the physical layer; and

stopping recording the conversation log if at a certain time point the symbol error rate is lower than the symbol error rate threshold and the duration exceeds a preset second time period threshold during record of the conversation log. Among which, the second time period threshold may be set as required, and will not be further delimited here.

By the above two ways, the record of the conversation log may be stopped when the conversation enters into a normal state, so that the storage space of the terminal may be saved, and a situation where too many unnecessary conversation logs are recorded may be avoided.

Furthermore, in some optional implementation modes, after the step of stopping recording the conversation log, the method may further include the steps of:

deleting the conversation log that has been recorded.

By deleting the conversation log that has been recorded after stopping recording the conversation log, unnecessary conversation logs may be cleaned, and the storage space of the terminal may be saved.

Because the storage space occupied by the conversation logs is large, in some preferred embodiments, after the step of saving the conversation log, the method further includes:

judging whether a WIFI is connected;

if yes, uploading the conversation log to the server; and

if not, uploading the conversation log to the server after a WIFI is connected.

Therefore, by uploading the conversation log after a WIFI is connected, a user may save web traffic and money.

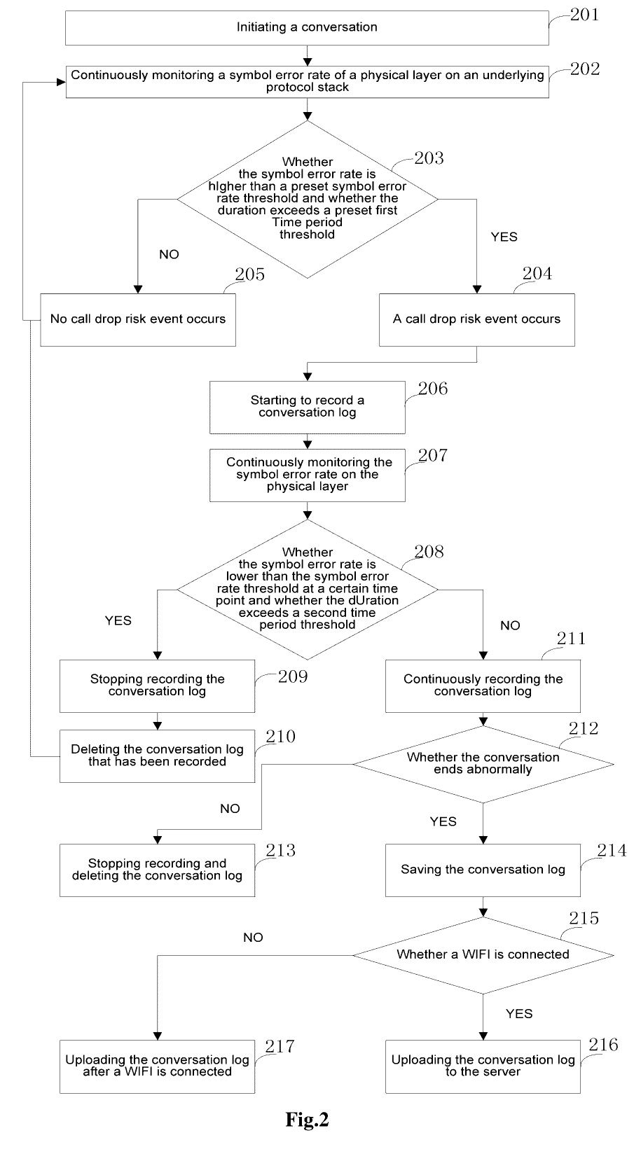

As shown in FIG. 2, it is a schematic flow chart of another embodiment of the method for testing call drop according to the disclosure.

The method for testing call drop includes the steps of:

In step 201: a conversation is initiated.

In step 202: a symbol error rate of a physical layer on an underlying protocol stack is monitored continuously.

In step 203: it is judged whether the symbol error rate is higher than a preset symbol error rate threshold (Vcrc) and whether the duration exceeds a preset first time period threshold.

In step 204: if yes, it is determined that a call drop risk event occurs (the protocol stack reports to a high level conversation module).

In step 205: if not, it is determined that no call drop risk event occurs and to return to step 202 for a continuous monitoring of the symbol error rate on the physical layer.

In step 206: a record of a conversation log is started based on the call drop risk event.

In step 207: the symbol error rate on the physical layer is continuously monitored.

In step 208: it is judged whether at a certain time point the symbol error rate is lower than the symbol error rate threshold at a certain time point and whether the duration exceeds a preset second time period threshold during during record of the conversation log.

In step 209: if yes, the record of the conversation log is stopped;

In step 210: the conversation log that has been recorded is deleted, and it is returned to step 202 for a continuous monitoring of the symbol error rate on the physical layer.

In step 211: if not, the conversation log is continuously recorded.

In step 212: it is determined whether the conversation ends abnormally.

In step 213: if not, the record of the conversation log is stopped and the recorded conversation log is deleted.

In step 214: if yes, the conversation log that has been recorded is saved.

In step 215: it is determined whether a WIFI is connected.

In step 216, if yes, the conversation log is uploaded to the server.

In step 217: if not, a WIFI is manually connected, and the conversation log is uploaded to the server after a WIFI is connected.

It may be seen from the above embodiment that, in the method for testing call drop according to the disclosure, a call drop conversation log (LOG) is automatically obtained and uploaded to a server by monitoring the symbol error rate on the physical layer during a conversation, so that the whole obtaining and uploading process may be accomplished automatically in a terminal while a user or a tester only needs to use the mobile phone normally; moreover, by carrying out a test based on the symbol error rate monitoring result, the terminal only obtains the conversation log in a call drop conversation, thus no large amount of invalid conversation logs will be generated and occupy the storage space of the terminal; moreover, because the symbol error rate is taken as the basis (for judgement), in case a call drop occurs, the probability of missing a drop scene may be lowered because a record of the conversation log has already been initiated before the call drop; and at the same time, the conversation log is automatically sent to the server, which is favorable for counting and further analyzing. Additionally, whether a conversation has returned to a normal level may be judged by a continuous monitoring of the symbol error rate; if yes, the record of the LOG will be stopped and the LOG that has already been recorded will be deleted, so that the storage space may be saved; meanwhile, whether a LOG is to be uploaded may be further determined by judging whether a WIFI is connected, thereby web traffic may be saved for the user.

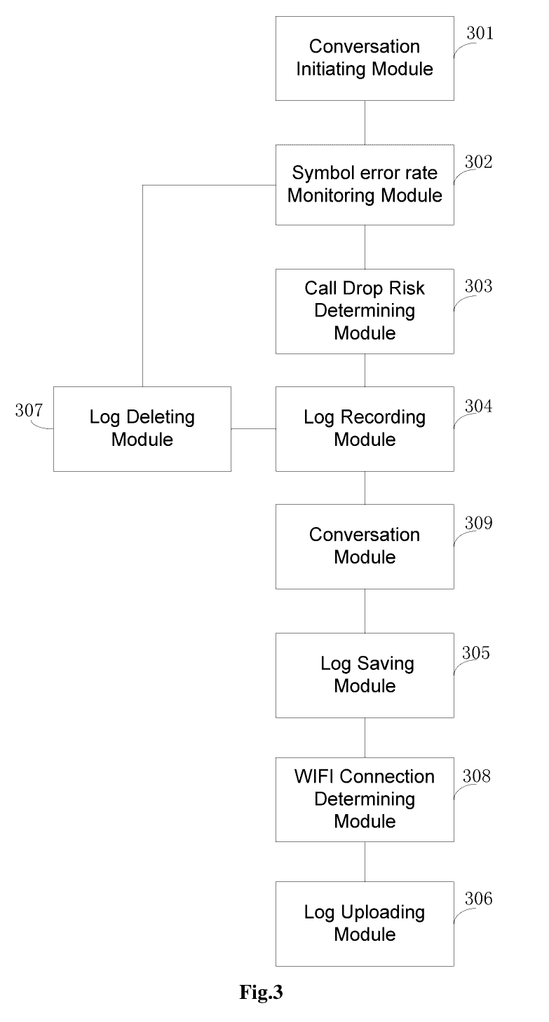

In the second aspect of the disclosure, there provides a device for testing call drop, thereby a LOG can be obtained in time and the call drop data can be analyzed, and moreover, no excessive space will be occupied. As shown in FIG. 3, it is a schematic diagram showing the module structure of one embodiment of the device for testing call drop according to the disclosure.

The device for testing call drop includes:

a conversation initiating module 301, configured for initiating a conversation; that is, a mobile terminal is turned on and a conversation mode is started;

a symbol error rate monitoring module 302, configured for continuously monitoring a symbol error rate on a physical layer;

among which, symbol error rate (SER) is an index for measuring a data transmission accuracy of data during a specified time period. Symbol error rate=Error Symbol Count During Transmission/Total Symbol Count Transmitted×100%; if there is an error symbol, there would be a symbol error rate; because a voltage of a signal may be changed due to degradation during signal transmission, the signal will be damaged during transmission, and as a result an error symbol will be generated; noise, a pulse caused by alternating current or lightning, transmission device failure and other factors may all result in a symbol error rate (for example, the signal transferred is 1, but the signal received is 0; and vice versa); due to various reasons, it is inevitable that an error may be generated during the transmission of digital signals; for example, a signal transferred may be distorted due to external disturbance during transmission or unsatisfactory quality of respective components in a communication system; when the disturbance or the signal distortion reaches a certain degree, an error will be generated; bit error rate (BER) is an index for measuring a data transmission accuracy of data during a specified time period. Symbol error rate=Count of Error Code Elements/Count Of Total Code Elements Transmitted; bit error rate=Count Of Error Bits/Count Of Total Bits Transmitted; symbol error rate/Bit error rate are the most commonly used index for data communication transmission quality; it indicates the transmission quality of a digital system by way of “one error bit among how many data bits”;

a call drop risk determining module 303, configured for determining that a call drop risk event occurs when the symbol error rate is higher than a preset symbol error rate threshold (Vcrc) and the duration exceeds a preset first time period threshold (Tcrc); that is, in such a case, a call drop risk tends to occur; the symbol error rate threshold is set according to different communication signals respectively, for example, the symbol error rate thresholds for a GSM signal, a 3G signal and a 4G signal are different, and should be specifically set according to specific situations; similarly, the first time period threshold also needs to be specifically set according to different specific situations;

a log recording module 304, configured for starting to record a conversation log on account of the call drop risk event; that is, a log record function is initiated at this point, and it starts to record the conversation log in real time so as to record the oncoming call drop event in the LOG;

a log saving module 305, configured for saving a conversation log when a conversation ends abnormally; and

a log uploading module 306, configured for uploading the conversation log saved to a server for the research staff to study the reason of the call drop event when a conversation ends abnormally.

It may be seen from the above embodiment that, in the device for testing call drop according to the disclosure, a call drop conversation log (LOG) is automatically obtained and uploaded to a server by monitoring the symbol error rate on the physical layer during a conversation, so that the whole obtaining and uploading process may be accomplished automatically in a terminal while a user or a tester only needs to use the mobile phone normally; moreover, by carrying out a test based on the symbol error rate monitoring result, the terminal only obtains the conversation log in a call drop conversation, thus no large amount of invalid conversation logs will be generated and occupy the storage space of the terminal; moreover, because the symbol error rate is taken as the basis (for judgement), in case a call drop occurs, the probability of missing a drop scene may be lowered because a record of the conversation log has already been initiated before the call drop; additionally, the conversation log is automatically sent to the server, which is favorable for counting and further analyzing.

Further, in some optional implementation modes, the symbol error rate monitoring module 302 is further configured for continuously monitoring the symbol error rate on the physical layer.

The log recording module 304 is further configured for stopping recording the conversation log if the symbol error rate is lower than the symbol error rate threshold at a certain time point during record of the conversation log.

Or, further, in other optional implementation modes, the symbol error rate monitoring module 302 is further configured for continuously monitoring the symbol error rate on the physical layer.

The log recording module 304 is further configured for stopping recording the conversation log if at a certain time point the symbol error rate is lower than the symbol error rate threshold and the duration exceeds a preset second time period threshold during record of the conversation log.

By the above two ways, the record of the conversation log may be stopped when the conversation enters into a normal state, so that the storage space of the terminal may be saved, and a situation where too many unnecessary conversation logs are recorded may be avoided.

Furthermore, in some optional implementation modes, the device further includes a log deleting module 307. The log deleting module 307 is configured for deleting the conversation log that has been recorded after the log recording module 304 stops recording the conversation log.

By deleting the conversation log that has been recorded after stopping recording the conversation log, unnecessary conversation logs may be cleaned, and the storage space of the terminal may be saved.

Because the storage space occupied by the conversation logs is large, in some preferred embodiments, the device further includes a WIFI connection determining module 308, which is configured for judging whether a WIFI is connected.

If yes, the log uploading module 306 is configured for uploading the conversation log to the server;

If not, the log uploading module 306 is configured for uploading the conversation log to the server after a WIFI is connected.

Therefore, by uploading the conversation log after a WIFI is connected, a user may save web traffic and money.

Another embodiment, which shows how the device for testing call drop according to the disclosure is applied to the method for testing call drop according to the disclosure, will be introduced below in conjunction with FIG. 2.

The method for testing call drop includes the steps of:

In step 201: the conversation initiating module 301 initiates a conversation.

In step 202: the symbol error rate monitoring module 302 continuously monitors a symbol error rate of a physical layer on an underlying protocol stack.

In step 203: the symbol error rate monitoring module 302 judges whether the symbol error rate is higher than a preset symbol error rate threshold (Vcrc) and whether the duration exceeds a preset first time period threshold.

In step 204: if yes, the call drop risk determining module 303 determines that a call drop risk event occurs (the protocol stack reports to a high level conversation module).

In step 205: if not, the call drop risk determining module 303 determines that no call drop risk event occurs, and to return to Step 202; and the symbol error rate monitoring module 302 continues monitoring the symbol error rate on the physical layer;

In step 206: the log recording module 304 starts to record a conversation log based on the call drop risk event;

In step 207: the symbol error rate monitoring module 302 continues monitoring the symbol error rate on the physical layer;

In step 208: during record of the conversation log, the symbol error rate monitoring module 302 judges whether the symbol error rate is lower than the symbol error rate threshold at a certain time point and whether the duration exceeds a preset second time period threshold;

In step 209: if yes, the log recording module 304 stops recording the conversation log;

In step 210: the log deleting module 307 deletes the conversation log that has been recorded, and it returns to Step 202 and the symbol error rate monitoring module 302 continues monitoring the symbol error rate on the physical layer;

In step 211: if not, the log recording module 304 continues recording the conversation log;

In step 212: the conversation module 309 judges whether the conversation ends abnormally;

In step 213: if not, the log recording module 304 stops recording the conversation log, and the log deleting module 307 deletes the conversation log recorded;

In step 214: if yes, the log saving module 305 saves the conversation log that has been recorded;

In step 215: the WIFI connection determining module 308 judges whether a WIFI is connected;

In step 216: if yes, the log uploading module 306 uploads the conversation log to the server;

In step 217: if not, a WIFI is manually connected, and the log uploading module 306 uploads the conversation log to the server after the WIFI is connected.

It may be seen from the above embodiment that, in the device for testing call drop according to the disclosure, a call drop conversation log (LOG) is automatically obtained and uploaded to a server by monitoring the symbol error rate on the physical layer during a conversation, so that the whole obtaining and uploading process can be automatically accomplished in a terminal while a user or a tester merely normally uses the mobile phone; moreover, by carrying out a test based on the symbol error rate monitoring result, the terminal only obtains conversation logs in a call drop conversation, thus no large amount of invalid conversation logs may be generated and occupy the storage space of the terminal; because the symbol error rate is taken as the basis (for judgement), in case a call drop occurs, the probability of missing a drop scene may be lowered because a record of the conversation log has already been initiated before the call drop; additionally, the conversation log is automatically sent to the server, which is favorable for counting and further analyzing. Additionally, whether a conversation has returned to a normal level may be judged by a continuous monitoring of the symbol error rate; if yes, the record of the LOG will be stopped and the LOG that has already been recorded will be deleted, so that the storage space may be saved; meanwhile, whether a LOG is to be uploaded may be further determined by judging whether a WIFI is connected, thereby web traffic may be saved for the user.

One embodiment of the disclosure further provides a computer storage medium on which a program is stored; when executed, the program may carry out part of or all of the steps in each implementation mode of the method for testing call drop according to the embodiments shown in FIG. 1-FIG. 2.

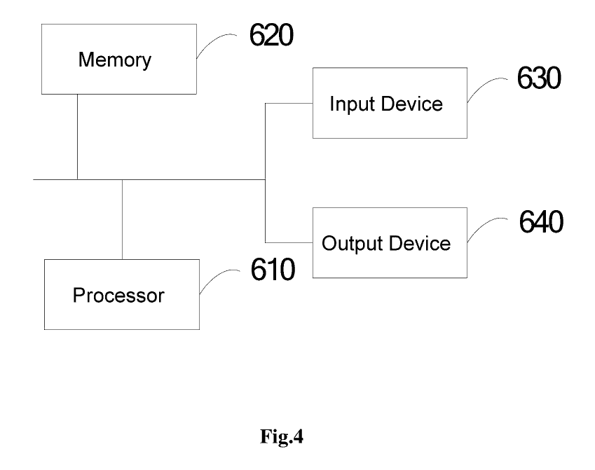

FIG. 4 is a diagram illustrating a hardware structure of an electronic device for testing call drop according to an embodiment of the disclosure. As shown in FIG. 4, the electronic device includes:

at least one processor 610 and a memory 620, wherein only one processor 610 is illustratively shown in FIG. 4.

The device for testing call drop may also include: an input device 630 and an output device 640.

The processor 610, memory 620, input device 630 and output device 640 may be connected via a bus or other means, wherein a connecting bus is illustratively shown in FIG. 4.

The memory 620, as a non-volatile computer readable storage medium, may be used to store non-volatile software programs, non-volatile computer executable programs and modules, such as the program commands/modules corresponded to the method for testing call drop according to the embodiments in the present disclosure. The processor 610, by running non-volatile software programs, commands and modules stored in the memory 620, performs various functional applications and data processing of the server, i.e., carries out the method for testing call drop according to the above embodiments in the present disclosure.

The memory 620 may include a program storage area and a data storage area, wherein the program storage area may be used to store application programs needed by an operating system or by at least one function, and the data storage area may be used to store data created by running the device for amplifying a video image, and the like. Moreover, the memory 620 may include a high speed random access memory, and also may include a non-volatile memory, such as at least one disk memory, flash memory, or other non-volatile solid state memory. According to some embodiments, the memory 620 may optionally include memories that are remotely setup with respect to the processor 610, and these remote memories may be connected to the device for amplifying a video image via a network connection. An example of such a network includes, but not limited to, internet, intranet, local area network, mobile communication network, and a combination thereof.

The input device 630 may receive input digital or character information, and generate key signal inputs concerned with user setting and functional control of the device for testing call drop. The output device 640 may include displaying means such as a display screen.

The at least one module is stored in the memory 620, and, when run by the at least one processor 610, executes the method for testing call drop according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices of the embodiments of the present disclosure exists in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, anc includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for testing call drop, comprising:
at a server;
initiating a conversation;
continuously monitoring a symbol error rate on a physical layer;
determining that a call drop risk event occurs if the symbol error rate is higher than a preset symbol error rate threshold and the duration exceeds a preset first time period threshold;
starting to record a conversation log on account of the call drop risk event; and
saving the conversation log and uploading it to a server if the conversation ends abnormally.

2. The method according to claim 1, wherein after the step of starting to record a conversation log, the method further comprises:
continuously monitoring the symbol error rate on the physical layer; and
stopping recording the conversation log if the symbol error rate is lower than the symbol error rate threshold at a certain time point during record of the conversation log.

3. The method according to claim 1, wherein after the step of starting to record a conversation log, the method further comprises:
continuously monitoring the symbol error rate on the physical layer; and
stopping recording the conversation log if the symbol error rate is lower than the symbol error rate threshold at a certain time point and the duration exceeds a preset second time period threshold during record of the conversation log.

4. The method according to claim 2 or 3, wherein after the step of stopping recording the conversation log, the method further comprises:
deleting the conversation log that has been recorded.

5. The method according to claim 1, wherein after the step of saving the conversation log, the method further comprises:
judging whether a WIFI is connected;
if yes, uploading the conversation log to the server; and
if not, uploading the conversation log to the server after the WIFI is connected.

6. A non-transitory computer-readable storage medium storing executable instructions that are configured to:
initiate a conversation;
continuously monitor a symbol error rate on a physical layer;
determine that a call drop risk event occurs if the symbol error rate is higher than a preset symbol error rate threshold and the duration exceeds a preset first time period threshold;
start to record a conversation log on account of the call drop risk event; and
save the conversation log and upload it to a server if the conversation ends abnormally.

7. An electronic device for testing call drop, comprising:
at least one processor; and
a memory communicably connected with the at least one processor;
wherein the memory is configured storing for storing instructions executable by the at least one processor, wherein execution of the instructions by the at least one processor causes the at least one processor to:
initiate a conversation;
continuously monitor a symbol error rate on a physical layer;
determine that a call drop risk event occurs if the symbol error rate is higher than a preset symbol error rate threshold and the duration exceeds a preset first time period threshold;
start to record a conversation log on account of the call drop risk event; and
save the conversation log and upload it to a server if the conversation ends abnormally.

8. The electronic device according to claim 7, wherein after the step to start to record a conversation log, the at least one processor is further caused to:
continuously monitor the symbol error rate on the physical layer; and
stop recording the conversation log if the symbol error rate is lower than the symbol error rate threshold at a certain time point during record of the conversation log.

9. The electronic device according to claim 7, wherein after the step to start to record a conversation log, the at least one processor is further caused to:
continuously monitor the symbol error rate on the physical layer; and
stop record the conversation log if the symbol error rate is lower than the symbol error rate threshold at a certain time point and the duration exceeds a preset second time period threshold during record of the conversation log.

10. The electronic device according to claim 8 or 9, wherein after the step to stop recording the conversation log, the at least one processor is further caused to:
delete the conversation log that has been recorded.

11. The electronic device according to claim 7, wherein after the step to save the conversation log, the at least one processor is further caused to:
judge whether a WIFI is connected;
if yes, upload the conversation log to the server; and
if not, upload the conversation log to the server after the WIFI is connected.
